(19) United States
(12) Patent Application Publication
(10) Pub. No.: US 2002/0040759 A1
(43) Pub. Date: Apr. 11, 2002

(54) Method for effecting a cross-the-grain bonding on veneer sheets in plywood manufacture

(76) Inventor: Kauko Juntunen, Nastola (FI)

Correspondence Address: Burton A. Amernick, Connolly Bove Lodge & Hutz LLP, Suite 800, 1990 M Street, N.W., Washington, DC, 20036-3425, US

(21) Appl. No.: 09/969,633

(22) Filed: Oct. 4, 2001

(30) Foreign Application Priority Data
Oct. 5, 2000 (FI) U20000390
May 16, 2001 (FI) 20011036

(51) Int. Cl. C09J 1/00

(52) U.S. Cl. 156/295; 156/304.1

(57) ABSTRACT

The present invention relates to a method for cross-the-grain bonding of veneer sheets in plywood manufacture. In the method, two adjacent veneer strips in an edge-to-edge disposition are bonded to each other or, alternatively, the surface of veneer sheet is reinforced by applying to the surface of the veneer sheet at least one substantially continuous stripe of glue.

The present invention relates to a method for achieving a cross-the-grain bonding of veneer sheets in plywood manufacture. The bonding operation is performed either to make an edge-to-edge joint between successive veneer sheets or to reinforce certain parts of veneer sheeting or sheet.

The manufacture of plywood involves a plurality of process steps wherein separate veneer sheets must be bonded together edge-to edge, as well as portions of veneer sheeting, either as sheets or continuous sheeting, must be reinforced. These operations must be carried out, e.g., on the veneer lathe station, the dryer station and the patching station.

On the lathe station, for instance, defective portions of veneer sheeting coming from the lather are trimmed away at a clipper that cuts the veneer sheet in the grain direction of the sheet before and after the defective portion. The narrow portions of sound veneer thus separated into veneer strips are joined together after the removal of the defective portion (and possible drying of the sheets) into continuous sheeting of veneer by way of crowding the successive sheets into an edge-to-edge relationship with each other and then joining the edges by plural glue-bonded strings that are displaced laterally at a distance from each other and run perpendicularly over the edges to be jointed. The glue-bonded string incorporates a high-strength reinforcement which is comprised of, e.g., textile fiber strands and is coated with a glue layer.

Alternatively, the removal of defective portions may be performed on dried sheets. Herein, green sheets are first trimmed to a predetermined length from sheeting coming from the veneer lathe, and the sheets are then taken as such to the dryer. After drying, the sheets are transferred onto a defect removal and composing line where the defective portions of veneer sheets are cut away and the sound portions are composed into continuous sheeting. Then, the sheeting may again be cut into sheets of a predetermined size. The composing operation is carried out in the above-described manner with the help of glue-bonded string. The string is typically a ready product coated with hot-melt glue, and the bonding to the sheet is achieved by heating the glue just prior to pressing the string onto the veneer sheet surface. Additionally, the joint is secured by glue applied as dots placed over the joint portions remaining between the strings. This kind of technique for composing veneer strips produces a continuous veneer sheet structure that is solid to handle and, furthermore, the continuous sheet is durable in the further process steps of plywood manufacture.

However, the string as such is problematic inasmuch the strength of the string makes it difficult to sever the string when the veneer sheets are being cut. On the other hand, the use of hot-melt glue requires a certain minimum strength from the string to take the heat of the glue. A durable joint made by strings can also cause problems under situations where the glued veneer strips may partially overlap each other during crowding. This kind of a circumstance is difficult to rectify inasmuch the string cannot yield so as to permit outdistancing of the veneer strips from the overlapping position to the position where their facing edges abut each other. Furthermore, bonding veneer strips with glue-coated strings cannot be used for exterior ply veneer sheets, because the strands of the glue-coated string would then remain visible on the surface of the outermost veneer sheet in the plywood.

In certain cases, veneer sheeting coming from a lathe may be advantageously reeled for intermediate storage before further processing. This technique is primarily employed for thin veneer peeled off from logs of certain wood species. Herein, the thickness of veneer is less than about 0.8 to 1 mm, e.g., for beech veneer sheet. The veneer sheeting to be reeled is generally reinforced for further processing by gluing an adhesive tape to each lateral edge of the sheeting. After intermediate storage, the reel of veneer sheeting is unwound and taken to drying. After drying, the sheeting is cut to sheets of predetermined size for the manufacture of the final product. Patching of veneer sheets also requires reinforcement at the lateral edges of veneer sheets. This measure is taken to keep down the number of defective sheets during handling.

The above-mentioned problems of conventional techniques are overcome and other desirable objectives are achieved by means of the features of the present invention characterized in appended claim 1.

In the context of the present invention, the term glue is used when reference is made to a compound that is or can be brought into an application form of such flowability that it can be applied to the surface of a veneer sheet as a stripe adhering thereto and, subsequent to the application, can be brought into a state of higher ductility. Even when set on the veneer sheet surface, the glue must retain a certain degree of toughness and elongation to permit flexing of the glue stripe within the flexibility of the veneer sheet itself. Respectively, the glue stripe must endure the possible elongation required to outdistance two overlapping sheet edges into an edge-to-edge abutting disposition. The tension strength of the glue stripe should be at least in the same order as the tension strength of the actual veneer in the direction across its grain direction. The tensile strength of the glue stripe can be adjusted by regulating the amount of the glue administered per length unit of the stripe.

A suitable compound for the gluing purpose is the polymer-based hot-melt glue conventionally used in the plywood industry. At ambient temperature, this kind of glue is ductile yet tough, but becomes almost flowable when heated. Equivalently, other types of conventional glues may be used such as those curable with the help of ambient air, a separate catalyst or by physical means such as heat or radiation.

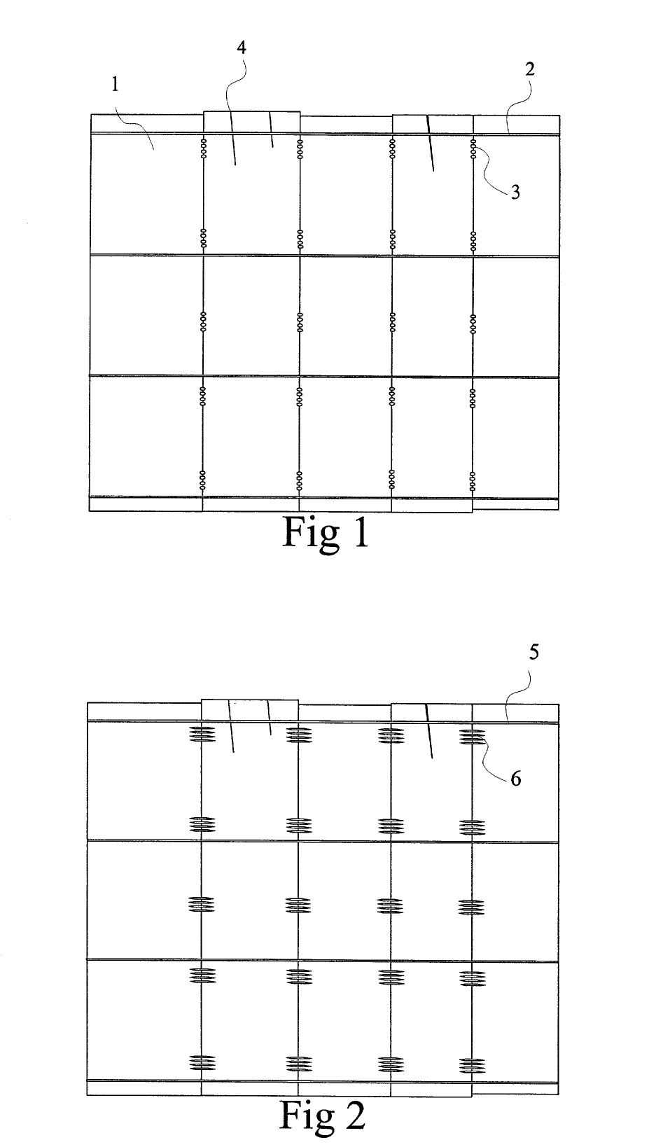

Next, the invention will be examined in greater detail by making reference to the attached drawings illustrating an embodiment suited for joining veneer sheets. More specifically, FIGS. 1 and 2 show two veneer sheets made by joining narrow veneer strips. In the drawing,

FIG. 1 shows a veneer sheet produced using a conventional jointing; and

FIG. 2 shows a veneer sheet produced using a jointing embodiment according to the invention.

In FIG. 1, veneer strips denoted by reference numeral 1 come from an upstream lathe station and they are already freed from defects such as knot holes and deeper notches at the lateral edges of the strips, by cutting the veneer sheeting leaving the lathe along the grain before and immediately after the defect. Next, the veneer strip leaving the cutting station is crowded tight with the preceding veneer strip so that the leading edge of the successive veneer strip abuts the trailing edge of the preceding veneer strip. During this crowding step, glue dots 3 are applied to the leading edge of the succeeding veneer strip so that the traveling strip catches along the glue drops dispensed from a suitable applicator. The glue-coated strings 2 are adhered to the surface of the edge-to-edge disposed veneer sheets by heating followed by pressing with a cooled roller.

In the embodiment shown in FIG. 2, the above-described type of conventional veneer sheet jointing is replaced by a jointing wherein the veneer strips crowded into an edge-to-edge relationship are bonded to each other by substantially continuous threads 5 of glue that run across the veneer strips (i.e. across the grain direction of the veneer strips). Additionally, the jointing achieved by the threads can be reinforced by applying over the abutting edges of the veneer strips a plurality of glue stripes 6 that are relatively short in respect to the cross-the-grain dimension of the veneer strip.

The glue stripes 5 and 6 can be made onto the veneer sheet surface by means of a glue applicator equipped with narrow-slit nozzles. The glue can be, e.g., hot-melt glue of a grade having a sufficient inherent strength when set. The glue must bond the veneer strips to each other sufficiently durably to pass the subsequent processing steps. After setting, the glue must possess relatively good bending and elongation strength properties. The glue can be applied to the top and/or bottom surface of the veneer strips.

According to a specific feature of the invention, the glue is applied to the points 5 and 6 of glue application so that the adjacent veneer strips to be crowded have not yet become abutting each other at the instant the flowing stripe of glue crosses the gap between the adjacent strips. In this fashion, it is possible to make the glue stripe sag slightly over the closing gap of the joint, whereby the crowding of the veneer strips makes a certain amount of glue to remain between the abutting edges of adjacent veneer strips.

The joint according to the invention also facilitates an embodiment, wherein the glue stripe 2 running in a substantially continuous manner across the veneer strips 1 is not entirely continuous, but instead, the dispensing of the glue stripe can be cut off in the middle region of the veneer strip. Nevertheless, e.g., the glue stripe shall run over splits 4 to assure a sufficient strength of the bonded veneer sheet. This controlled feature can be accomplished by utilizing a camera equipped with machine vision for monitoring the sheet strips coming from the clipper and the dryer.

Furthermore, the joint according to the invention between abutting veneer strips does not need a specific fixed starting point for the application of the glue stripe as is necessary when a glue-coated string is used, but rather the application of glue to the surface of veneer strips can be commenced starting directly from the leading edge of the first veneer strip.

Two veneer strips can be bonded according to the invention in an edge-to-edge relationship with each other by way of applying the glue stripe along the joint so that the glue simultaneously covers the opposite edges of both veneer strips. Also in this embodiment, there is maintained a narrow gap about 2 mm wide between the opposed edges of the adjacent veneer strips at the instant of glue application. The opposed veneer strips are subsequently crowded, whereby a portion of the glue can also reach the square-edge surfaces of the opposed veneer strips. This bonding technique is particularly advantageous in the bonding of veneer strips intended to serve as the exterior ply of veneer panels.

Furthermore, it is possible to apply the glue stripes to both lateral edges of continuous veneer sheeting coming from a lathe station, thus imparting higher strength to the edges of the sheeting. This feature is utilized in conjunction with thin sheeting that after being peeled off at the lathe is reeled for intermediate storage before drying. Also sheeting or sheets to be taken to patching can be reinforced at their lateral edges in a similar manner thus permitting the patching of defects located in a close vicinity to the lateral edge of sheeting or sheets.

What is claimed is:

1. A method for effecting a cross-the-grain bonding on veneer sheets and sheeting in plywood manufacture, characterized in that across the surface of the veneer sheet(ing) is applied at least one continuous stripe of glue in a flowable state of such a grade that upon setting assumes a ductile state on the veneer sheet(ing) surface.

2. The method according to claim 1, characterized in that the amount of the glue per length unit of the stripe is adjusted in order to control the tensile strength of the set stripe.

3. The method according to claim 1, characterized in that a glue is used which is flowable at an elevated temperature but becomes ductile at ambient temperature.

4. The method according to claim 1, 2 or 3, characterized in that the glue stripe is applied essentially perpendicular to the grain of the veneer sheet(ing).

5. The method according to claim 1, characterized in that the glue stripe is applied across an edge-abutting joint between adjacent veneer sheets.

6. The method according to claim 5, characterized in that the joint is closed by crowding the adjacent veneer sheets in the plane of the sheets after the application of the glue stripe.

7. The method according to claim 1, characterized in that the glue stripe is applied along at least one of the lateral edge regions of continuous veneer sheeting.
